(19) United States
(12) Patent Application Publication
(10) Pub. No.: US 2026/0235811 A1
(43) Pub. Date: Aug. 13, 2026

(54) Adiabatic Waveguide Loop with Arbitrary Offset

(71) Applicant: Ciena Corporation, Hanover, MD (US)

(72) Inventors: Antoine Bois, Québec (CA); Alexandre Delisle-Simard, Québec (CA)

(73) Assignee: Ciena Corporation, Hanover, MD (US)

(21) Appl. No.: 19/195,792

(22) Filed: May 1, 2025

Related U.S. Application Data
(60) Provisional application No. 63/756,992, filed on Feb. 11, 2025.

(51) Int. Cl. G02B 6/125; G02B 6/13; G02F 1/035

(52) U.S. Cl. CPC G02B 6/125; G02B 6/13; G02F 1/035

(57) ABSTRACT

An optimized adiabatic waveguide loop geometry achieves arbitrary lateral offsets (Δy) through a continuously varying curvature profile, thereby eliminating unnecessary stationary points, abrupt transitions, and redundant straight segments. Conventional adiabatic waveguide bends suffer from suboptimal curvature variations, stationary points, increased optical losses, and extended device footprints. The disclosed waveguide loop addresses these limitations by carefully selecting geometric parameters, including curvature ramp rate (λ), minimum bend radius (rₘᵢₙ), and the length (L) of a circular segment to achieve the desired offset. This geometry significantly reduces scattering and radiation losses while enabling compact device footprints suitable for densely integrated photonic circuits. Such loops are particularly beneficial for electro-optic modulators, Sagnac reflectors, multi-pass thermal phase shifters, and interferometers, substantially enhancing optical-electrical velocity matching and reducing electro-optic modulation degradation. The disclosed design provides a versatile, empirically tunable solution for high-performance photonic applications requiring large-angle bends, precise lateral offsets, and superior optical performance.

### CROSS-REFERENCE TO RELATED APPLICATIONS

The present disclosure claims priority to U.S. Provisional Patent Application No. 63/756,992, filed Feb. 11, 2025, the contents of which are incorporated by reference in their entirety.

### FIELD OF THE DISCLOSURE

The present disclosure relates generally to optical devices. More particularly, the present disclosure relates to an adiabatic waveguide loop with arbitrary offset.

### BACKGROUND OF THE DISCLOSURE

Waveguide bends are critical components within integrated photonic circuits, allowing optical signals to be efficiently routed around corners, obstacles, or through complex optical layouts. A fundamental challenge in waveguide bend design involves minimizing optical losses associated with the curvature, while also ensuring a compact footprint to enable dense integration of photonic components on a chip. To address these competing objectives, various waveguide bend geometries have been developed, including fixed-radius circular arcs, adiabatic bends (commonly referred to as Euler bends), and compound or composite curves (such as S-shaped bends). Among these, adiabatic bends are particularly advantageous due to their gradually varying curvature profiles, which reduce abrupt transitions in refractive index and thus significantly mitigate radiation and scattering losses. Typically, adiabatic waveguide bends achieve this by progressively varying curvature from an initial straight or minimally curved segment, smoothly increasing curvature toward a peak value at the midpoint, and then symmetrically decreasing curvature back to a straight or near-zero curvature segment at the exit. Such gradual curvature transitions help maintain the integrity of the optical mode, minimizing disturbances and ensuring low-loss optical signal propagation. Nonetheless, existing adiabatic bend designs can exhibit limitations such as unintended stationary points, extended path lengths, and suboptimal curvature variations, all of which contribute to higher optical losses and increased device footprints.

### BRIEF SUMMARY OF THE DISCLOSURE

The present disclosure addresses limitations associated with conventional compound adiabatic waveguide bends that typically employ piecewise-defined curvature profiles. These segmented approaches inherently introduce stationary points-locations along the waveguide path at which the curvature derivative momentarily becomes zero-leading to inefficient use of available chip area, increased device footprints, and diminished optical performance due to elevated scattering and radiation losses. Additionally, such stationary points necessitate abrupt transitions and redundant straight segments, exacerbating optical propagation inefficiencies. The disclosed approach overcomes these challenges by presenting an enhanced adiabatic waveguide loop geometry capable of achieving precise, arbitrary lateral offsets (Δy) via a continuously varying, smoothly transitioning curvature profile. By maintaining continuous curvature variation throughout the waveguide path, the proposed design eliminates unnecessary stationary points, avoids abrupt transitions, and removes redundant straight segments, thereby optimizing both optical performance and spatial efficiency.

Specifically, the disclosed waveguide loop geometry is systematically optimized by carefully selecting and tuning critical geometric parameters, including the curvature ramp rate (λ), minimum bend radius (rₘᵢₙ), and the length (L) of a strategically placed central circular segment. By empirically adjusting these parameters, the disclosed geometry achieves an optimal balance between minimal optical losses, compactness, and precise lateral offset capability, enabling substantially reduced footprints and superior optical performance. Such optimized loops are particularly advantageous in performance-sensitive photonic devices, such as electro-optic (EO) modulators, Sagnac-based optical reflectors, and multi-pass thermal phase shifters. For EO modulators, the improved waveguide geometry significantly enhances velocity matching between optical and radio-frequency (RF) signals, substantially reducing EO modulation degradation. Additionally, the disclosed geometry facilitates tighter device integration, making it highly suitable for dense, space-constrained photonic circuits. Overall, the disclosed waveguide loop geometry provides a versatile, empirically tunable design framework beneficial to a broad range of photonic applications demanding efficient large-angle bends, precise lateral offsets, reduced insertion losses, and optimized spatial utilization.

### BRIEF DESCRIPTION OF THE DRAWINGS

The present disclosure is detailed through various drawings, where like components or steps are indicated by identical reference numbers for clarity and consistency.

FIG. 1 illustrates a graph of a comparative illustration of waveguide geometries for adiabatic (Euler) bends versus conventional circular bends.

FIGS. 2 and 3 illustrate adiabatic bends with conventional compound-bend configurations that fulfill large bend angles with an offset.

FIG. 4 illustrates an adiabatic bend, namely a compound bend with arbitrary offset, according to the present disclosure.

FIG. 5 illustrates a graph of the compound bend with arbitrary offset.

FIG. 6 illustrates a flowchart of a method of constructing such a bend.

FIG. 7 illustrates a graph of the relationship between the adjusted curvature fraction γ′ and the effective minimum radius of curvature rₘᵢₙ′, highlighting an imposed upper limit to maintain practical compactness of the waveguide loop.

FIGS. 8-11 illustrate optimized adiabatic waveguide loops configured to achieve an identical vertical offset Δy with different output angles (90°, 180°, 270°, and 360°), demonstrating the method's versatility for compact, low-loss photonic routing.

FIG. 12 illustrates a compact optical delay path formed by sequentially integrating a conventional 90° adiabatic bend and an optimized 90° bend with lateral offset, demonstrating the practicality and flexibility of the disclosed waveguide loop design approach.

### DETAILED DESCRIPTION OF THE DISCLOSURE

The present disclosure relates to an adiabatic waveguide loop configured to achieve an arbitrary lateral offset (Δy) while maintaining a continuously varying curvature profile. The disclosed approach enables the design of optimally compact, low-loss adiabatic bends tailored to the performance requirements of various integrated photonic devices, including, but not limited to, Sagnac-based optical reflectors, dual-entry photodiode routing structures, and multi-pass thermal phase shifters. One primary motivation for this disclosure arises from the specific need to replace excessively long waveguide loops currently utilized in electro-optic (EO) modulators for achieving precise velocity matching between optical signals and radio frequency (RF) signals. In such modulators, efficient EO modulation depends critically on maintaining synchronized propagation speeds of the optical and RF signals to avoid degradation of modulation efficiency and signal integrity. Non-limiting examples of electro-optic modulator material platforms that can benefit from this improved loop design include thin-film lithium niobate (TFLN) and barium titanate (BaTiO₃ or BTO).

To maintain optimal velocity matching, designers typically employ waveguide loops that periodically realign optical and RF signals at regular intervals, thereby reducing cumulative phase mismatch and associated EO performance degradation. However, if the loops used for this purpose are overly extended, the distance between alignment points becomes excessively large, diminishing the frequency of velocity corrections and consequently increasing EO modulation degradation. Thus, there exists a significant demand within the integrated photonics field for compact, efficient, and low-loss adiabatic loops capable of providing the necessary lateral offset within a minimal path length. The disclosed waveguide loop geometry specifically addresses this need by achieving a precise offset (Δy) with shorter total length and reduced insertion loss, ensuring frequent realignment of optical and RF signals and ultimately maximizing the modulator's overall EO performance.

As used throughout this disclosure, the terms ‘adiabatic bend’ and ‘Euler bend’ are interchangeable and refer explicitly to a waveguide bend characterized by a curvature profile that varies continuously and smoothly, without abrupt changes, along the direction of optical propagation. Waveguide bends of this type are advantageous for redirecting guided optical signals with minimal scattering and radiation losses while simultaneously supporting compact photonic circuit layouts.

Total scattering losses within waveguide bends typically originate from multiple interrelated factors, each contributing uniquely to the overall optical performance of the bend. Understanding and minimizing these loss mechanisms is crucial for optimal design.
(1) Propagation Loss (α(1/r)): This type of loss, often quantified in decibels per unit length (dB/cm or dB/mm), is directly dependent upon the local radius of curvature (r), equivalently expressed through its reciprocal—the local curvature (1/r). Physically, waveguide segments with large bend radii (low curvature) typically exhibit lower scattering and radiation losses, due to gentler transitions in the guided mode's optical path. Conversely, tighter bends characterized by smaller radii (higher curvature) induce stronger optical confinement disturbances, resulting in increased radiation leakage and scattering losses. As a general principle, designers aim to maximize the minimum bend radius where feasible to maintain acceptable propagation loss.
(2) Loss Due to Curvature Discontinuities: Abrupt transitions or sudden changes in curvature profiles are significant sources of loss within waveguide bends. These discontinuities commonly arise at junctions between segments having distinctly different radii or in piecewise-defined waveguide curves where curvature is not smoothly matched at segment interfaces. Such abrupt curvature changes disturb the guided optical mode by partially scattering it out of the core region, thereby increasing radiation losses and reducing overall waveguide efficiency. Eliminating these discontinuities through a continuously varying curvature profile (as provided in the disclosed design) is therefore critical to minimizing these undesired scattering mechanisms.
(3) Loss from the Linear Rate of Change in Curvature (λ): This loss mechanism arises even in cases where the curvature profile itself is continuous. Specifically, losses can occur when the rate at which curvature changes along the waveguide path—the curvature gradient (denoted by λ and defined as the linear rate of change in curvature per unit length)—is excessively steep or rapid. High curvature gradients can introduce mode perturbations that compromise optical confinement, triggering radiation into cladding regions and subsequent scattering losses. Consequently, optimal waveguide designs carefully control the magnitude of λ, balancing the requirement for compactness against the need to avoid rapid curvature transitions. By carefully tuning and limiting this curvature ramp rate, the disclosed approach maintains smooth mode propagation and achieves superior optical performance.

To optimize a waveguide bend, designers must simultaneously address several interrelated objectives, including minimizing total optical losses, reducing the waveguide's overall path length, and limiting its physical footprint to enable denser photonic integration. These objectives often impose competing constraints; thus, achieving an optimal balance requires careful engineering. By designing an adiabatic (Euler) bend characterized by a continuously varying curvature profile, where curvature gradually and smoothly ramps up and down without abrupt transitions or discontinuities, the disclosed approach effectively mitigates each of the previously identified scattering and radiation loss mechanisms. Consequently, this design strategy results in an improved trade-off among critical performance parameters—low optical losses, compact footprint, reduced propagation length, and compatibility with fabrication limitations—making it highly suitable for advanced photonic integration.

An adiabatic waveguide bend—commonly referred to as an Euler bend—is traditionally conceptualized as including three distinct segments, each segment designed to contribute to a smooth, continuous transition in waveguide curvature:
(1) Ramp-Up Segment (curvature transition from 1/r=0 to 1/r=1/rₘᵢₙ): In this initial segment, curvature gradually increases from zero curvature (corresponding to a straight waveguide section) to a maximum curvature value (1/rₘᵢₙ), typically at a predetermined linear rate A. By incrementally increasing curvature, this ramp-up portion enables the guided optical mode to smoothly adjust to the curvature, significantly reducing radiation and scattering losses that otherwise result from abrupt curvature transitions.
(2) Constant Curvature Circular Segment (1/r=1/rₘᵢₙ): In this central segment, the waveguide maintains a constant curvature corresponding to a circular arc with radius rₘᵢₙ. The primary function of the circular segment is to provide a stable, uniform curvature over a defined waveguide length. The extent of this segment can be adjusted based on specific routing and layout requirements, such as achieving a desired angular bend or lateral offset. Maintaining uniform curvature in this segment facilitates consistent optical mode confinement, simplifies waveguide routing, and contributes to predictable and stable optical performance.
(3) Ramp-Down Segment (curvature transition from 1/r=1/rₘᵢₙ back to 1/r=0): This final segment mirrors the initial ramp-up segment, with the curvature smoothly and symmetrically decreasing from the maximum value (1/rₘᵢₙ) back down to zero curvature at the same linear rate λ. By ensuring symmetry in curvature transitions, the ramp-down segment allows the guided optical mode to transition smoothly from a bent region back into a straight waveguide region. Such gradual reduction of curvature mitigates mode mismatch and minimizes scattering losses, preserving mode integrity at the waveguide exit.

By carefully combining these three segments, the Euler bend provides a waveguide geometry free from abrupt changes in curvature magnitude and slope, thereby significantly improving mode quality and minimizing overall optical losses associated with bending. Additionally, the lengths of each segment, together with the chosen minimum radius of curvature (rₘᵢₙ) and curvature ramp rate (λ), can be strategically tailored to optimize performance metrics, effectively balancing competing constraints such as device footprint, acceptable optical losses, manufacturing feasibility, and design flexibility.

The coordinates of an adiabatic curve are found by integration,

$$a . x ( s ) = {\int }_{0}^{s} cos ( λ {s}^{2} / 2 ) ds ,$$

$$b . y ( s ) = {\int }_{0}^{s} sin ( λ {s}^{2} / 2 ) d s .$$

An adiabatic bend is generally regarded as a superior alternative to a simple circular bend in optical waveguide routing because it effectively avoids abrupt discontinuities in the local curvature profile, which are a significant source of radiation and scattering losses. By employing a continuously varying curvature profile—gradually increasing and then symmetrically decreasing curvature—an adiabatic bend substantially eliminates sharp transitions that can degrade optical mode quality. Consequently, this design approach reduces propagation losses attributable to curvature-induced scattering. Nevertheless, when designing an adiabatic bend for a fixed total angular turn (i.e., a specified total bending angle), this inherently smoother curvature variation can lead to an increased overall optical path length compared to a simple circular bend. To mitigate the impact on total waveguide length, designers may choose to reduce the minimum radius of curvature (1/rₘᵢₙ), thereby achieving a more compact overall layout without significantly compromising optical performance. Thus, an optimal balance must be achieved among curvature smoothness, path length, minimum radius constraints, and acceptable optical losses.

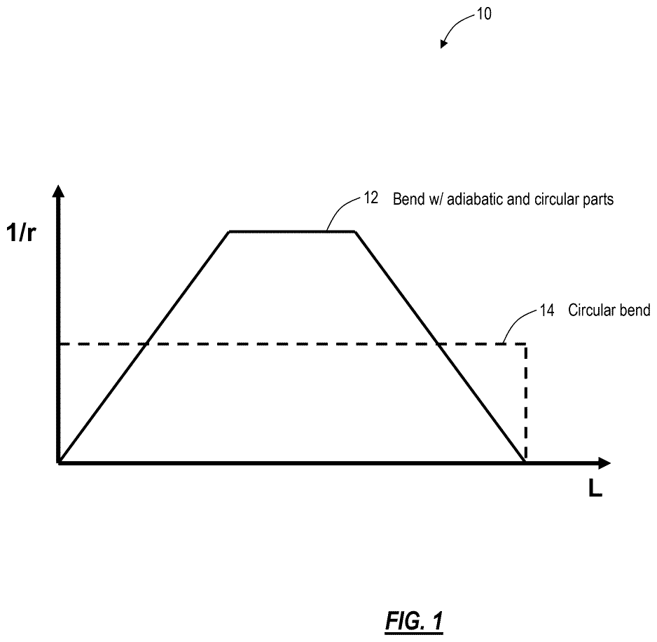

FIG. 1 illustrates a graph 10 of a comparative illustration of waveguide geometries for adiabatic (Euler) bends 12 versus conventional circular bends 14, highlighting how variations in segment length, curvature ramp rate (λ), and the constant-curvature portion significantly influence the total bend length and path characteristics. In particular, FIG. 1 compares two distinct bend geometries designed to achieve the same lateral vertical offset Δy and angular turn of 180°, clearly demonstrating differences in their resulting physical footprints and curvature distributions. As depicted, the Euler-type (adiabatic) bend 12 includes smoothly varying curvature transitions, where the curvature increases gradually from zero to a maximum value (1/rₘᵢₙ), remains briefly constant, and then decreases symmetrically back to zero. In contrast, the conventional bend 14 typically employs circular arcs with abrupt transitions between straight segments and curved regions. The fraction of the Euler bend's total length over which the curvature remains constant at the maximum value (1/rₘᵢₙ) is denoted by the parameter γ. Specifically, γ quantifies the proportion of the bend spent in this constant-curvature region, directly affecting both the total path length and the associated scattering losses. By adjusting γ alongside other critical parameters such as curvature ramp rate A and minimum radius of curvature rₘᵢₙ, designers can systematically optimize an adiabatic bend to achieve the desired balance among optical loss performance, device footprint, and practical fabrication constraints.

In FIG. 1, the Euler bend 12 clearly exhibits smoother curvature variations with fewer abrupt transitions compared to the conventional bend 14 geometry, which employs sharp junctions between straight segments and fixed-radius arcs. As illustrated, the Euler bend 12 achieves the same offset Δy with reduced overall path length, highlighting its advantages in compact, densely integrated photonic layouts.

Scattering losses in waveguide bends are inherently influenced by fabrication processes and resulting waveguide characteristics, including cross-sectional geometry, surface roughness, and material composition. Due to the variability introduced by different manufacturing techniques and material platforms, identifying optimal values for parameters such as curvature ramp rate A and minimum radius rₘᵢₙ commonly relies on empirical measurement rather than exclusively computational approaches. Practical considerations, such as wafer-scale fabrication uniformity, etching accuracy, and reproducibility, frequently necessitate iterative experimental characterization to identify and tune optimal bend parameters for achieving minimal propagation losses.

In practice, testing all combinations of bend angles (e.g., 0°-360°) with every potential combination of curvature ramp rates A and minimum radii rₘᵢₙ would be impractical. Instead, standardized test bends—often employing a 90° turn—are typically selected as benchmarks to experimentally evaluate candidate parameters. By systematically measuring losses from these standardized test structures, optimal or near-optimal parameter sets can be rapidly identified. Once determined, these parameter values can be effectively scaled or adapted to accommodate different angular extents or more intricate waveguide routing configurations.

A significant design challenge arises when an adiabatic bend requires large angular turns (e.g., at or exceeding 180°) combined with precise lateral offset Δy. In a Cartesian coordinate framework—assuming initial optical propagation along the +x axis—this offset Δy explicitly denotes the vertical displacement between the waveguide's output and input ports. Achieving such bends efficiently becomes especially critical in densely packed photonic layouts like integrated interferometers, Sagnac reflectors, optical delay lines, or photonic circuits employing tightly spaced 2×2 couplers. The disclosed Euler bend geometry, featuring smooth, continuously varying curvature profiles optimized through parameters λ, rₘᵢₙ, and γ, provides an effective and compact solution. By precisely engineering these curvature transitions, this approach significantly reduces physical footprint while maintaining superior optical performance, thereby enabling advanced photonic designs with stringent offset and spatial constraints.

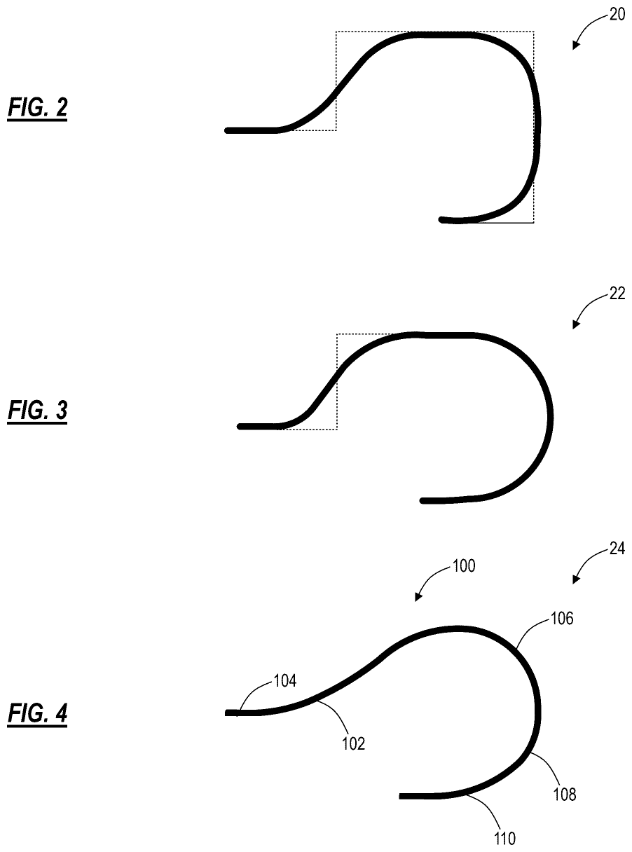

FIGS. 2 and 3 illustrate conventional compound-bend waveguide configurations 20, 22 designed to achieve large angular turns (180° in this example) along with a specified vertical offset Δy. While these approaches fulfill the basic routing requirements, they inherently introduce multiple stationary points—regions along the waveguide path at which curvature momentarily returns to zero (i.e., 1/r=0). The presence of such stationary points is suboptimal, as it unnecessarily increases the total optical path length, expands the device footprint, and introduces additional curvature transitions, thereby increasing scattering and radiation losses. Specifically, FIG. 2 depicts a configuration 20 composed of two 90° clothoid bends joined by an intermediate S-bend segment. This arrangement inherently includes three stationary points: one at each junction between clothoids and the S-bend, and another within the central S-shaped segment itself. Similarly, FIG. 3 shows an alternative conventional configuration 22 including a single 180° clothoid bend combined with an S-bend. Although slightly improved over FIG. 2 by reducing the stationary points from three to two, this configuration 22 still includes unnecessary internal transitions and stationary points.

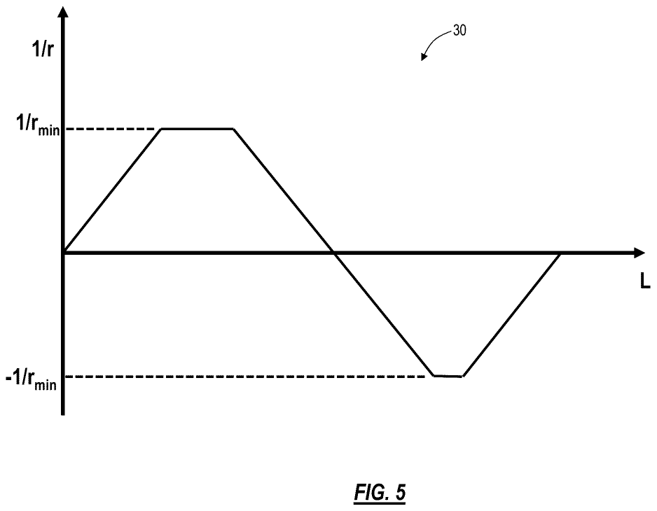

In contrast, FIG. 4 illustrates the improved waveguide bend geometry 24 described by the present disclosure, designed specifically to overcome the limitations seen in the configurations 20, 22 of FIGS. 2 and 3. The waveguide bend geometry 24 shown in FIG. 4 achieves the same angular bend (180°) and vertical offset Δy while significantly reducing or entirely eliminating intermediate stationary points. This optimal design accomplishes continuous curvature variation throughout the entire path without intermediate straight segments or abrupt curvature transitions. As clearly depicted, the absence of stationary points along the waveguide path in the waveguide bend geometry 24 results in a more streamlined, compact layout with notably reduced path length and minimal scattering losses. Consequently, the waveguide bend geometry 24 of FIG. 4 represents a superior solution, balancing optical performance, device footprint, and practical fabrication constraints far more effectively than conventional designs exemplified by FIGS. 2 and 3.

FIG. 5 illustrates a detailed graph 30 of a compound adiabatic bend configuration according to the present disclosure, specifically designed to achieve an arbitrary lateral offset Δy. In this graph 30, the horizontal axis represents the longitudinal position along the waveguide propagation direction (x-axis), while the vertical axis indicates the lateral offset (y-axis). The depicted waveguide geometry demonstrates a carefully optimized curvature profile that smoothly transitions from an initially straight segment (zero curvature) to a peak curvature, subsequently following a smoothly varying, compound-curvature path configured to produce the desired lateral offset.

As shown in FIG. 5, the waveguide path is divided into distinct segments, beginning with an initial curvature ramp-up region, followed by a smoothly varying curvature segment, and finally concluding with a symmetric curvature ramp-down region. Importantly, FIG. 5 highlights the absence of stationary points—locations where curvature momentarily returns to zero—within the internal segments, underscoring the continuous nature of the curvature profile. By precisely controlling the curvature ramp rate λ, the minimum radius of curvature rₘᵢₙ, and the segment lengths, the illustrated waveguide geometry achieves a predetermined lateral offset Δy while maintaining an optimally short total path length.

Compared to conventional compound bends, the continuous and gradual curvature variations illustrated in FIG. 5 eliminate abrupt transitions and intermediate straight sections, significantly reducing scattering losses and overall optical propagation losses. The optimized path shown in FIG. 5 thus provides an improved solution for integrated photonic circuits, enabling compact footprint, efficient space utilization, and superior optical performance for applications requiring precise lateral offsets, such as tightly integrated interferometers, electro-optic modulators, Sagnac reflectors, and advanced optical routing layouts.

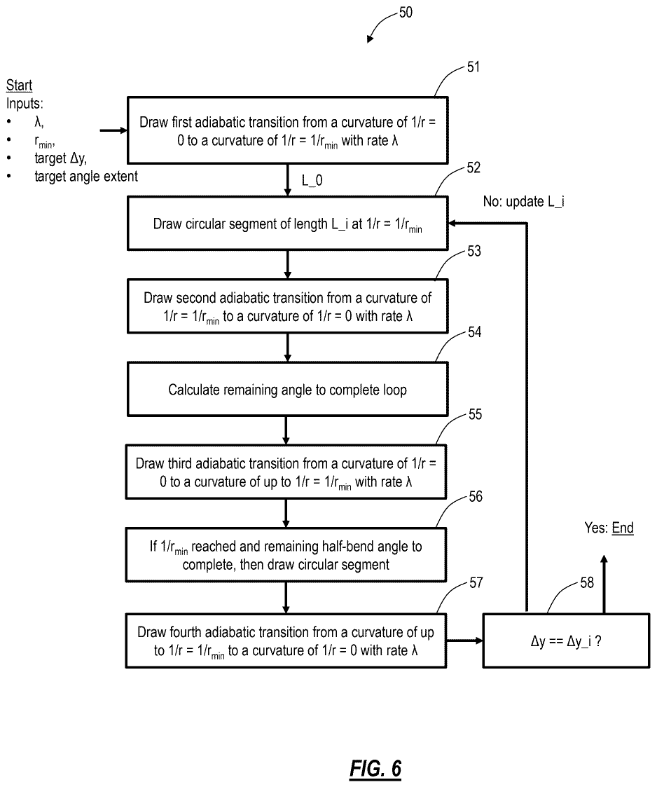

FIG. 6 illustrates a detailed flowchart depicting a structured, iterative process 50 for constructing an optimized compound adiabatic waveguide bend capable of achieving an arbitrary lateral offset Δy. Starting from predefined reference parameters—namely the curvature ramp rate (λ) and the minimum radius of curvature (rₘᵢₙ)—the process 50 systematically defines the waveguide path through a carefully sequenced combination of curvature transitions and circular segments. Each numbered step shown in FIG. 6 corresponds precisely to the following detailed description:

Step 51 (First Adiabatic Transition): The curvature smoothly ramps upward from an initially straight waveguide segment (curvature 1/r=0) to the maximum curvature value (1/r=1/rₘᵢₙ) at the defined adiabatic rate λ. This gradual transition reduces scattering losses by avoiding abrupt changes in waveguide curvature.

Step 52 (Circular Segment at Constant Curvature): After achieving maximum curvature (1/rₘᵢₙ), the waveguide path continues with a circular arc segment. The length (L) of this segment determines the lateral offset Δy, enabling precise control of vertical displacement within layout constraints.

Step 53 (Second Adiabatic Transition): Curvature is gradually reduced from the maximum curvature (1/rₘᵢₙ) back to zero (1/r=0), employing the same adiabatic curvature ramp rate A to ensure mode continuity and minimize scattering losses.

Step 54 (Third Adiabatic Transition): The waveguide curvature ramps up once again from zero curvature (1/r=0) toward a curvature value specifically calculated based on the remaining angle required to complete the loop. During this step, parameters such as the fraction γ of the curvature segment at 1/rₘᵢₙ are adjusted, ensuring that curvature does not exceed the maximum allowable value (1/r 1/rₘᵢₙ) and remains consistent with the reference curvature ramp rate λ.

Step 55 (Optional Constant-Curvature Arc Segment): If γ determined from step 54 is greater than zero, the method introduces an additional circular arc segment with curvature at the maximum radius (1/rₘᵢₙ). This segment allows for fine adjustment of the final bend geometry, angular coverage, and layout optimization.

Step 56 (Fourth Adiabatic Transition): This step mirrors step 54, symmetrically decreasing the curvature back to zero (1/r=0) using the same controlled curvature ramp rate λ, ensuring mode stability and minimizing scattering losses at the transition back to straight waveguide segments.

Step 57 (Final Offset Verification): At this stage, the achieved vertical offset Δy is verified against the desired design specification. If the offset matches the intended target, the design is finalized. If not, the process returns iteratively to earlier steps (such as adjusting segment length L or parameters γ and λ) to refine the geometry until the targeted offset Δy is accurately obtained.

Step 58 (Completion and Finalization): Once the desired offset Δy and bend geometry are verified, the method concludes, finalizing the waveguide layout for fabrication. This step ensures that the resulting adiabatic waveguide bend satisfies all critical performance criteria, including optimal footprint, minimal scattering loss, and precise spatial alignment.

Fresnel integrals, which underpin the mathematical representation of clothoid (Euler) bends, inherently lack closed-form analytical solutions and must be evaluated numerically. As a consequence, it becomes challenging to analytically determine or predict the exact final lateral offset (Δy) contributed by the circular segment within the adiabatic bend geometry. Specifically, while the length (L) of the constant-curvature circular segment serves as the primary free parameter influencing the resulting offset Δy, no explicit analytical expression exists that directly relates these two quantities without resorting to numerical approximation or iterative methods. Therefore, practical determination of the required circular segment length typically relies on numerical optimization algorithms—such as the secant method, Newton-Raphson, or other quasi-Newton iterative techniques—to efficiently converge upon the precise length L necessary to achieve the targeted offset Δy. These iterative procedures rapidly refine the length parameter based on successive approximations, effectively narrowing down to an optimal solution within a minimal number of iterations. Alternatively, to streamline this iterative design process, designers may precompute and tabulate a comprehensive set of offset-versus-length (Δy−L) relationships as lookup tables. Such lookup tables, derived from numerical simulations or experimental measurements, allow designers to quickly select a suitable initial estimate of L, significantly accelerating the overall design optimization and reducing computational overhead.

Further, at step 54, the remaining angular extent required to complete the waveguide loop may be defined as β′, expressed in radians. To precisely control the waveguide curvature profile and simplify numerical optimization, a curve normalization parameter α may be introduced, defined explicitly as:

$$a = {r}_{m i n} √ ( π ( 1 - γ ) π / 2 ) ,$$

where the reference angle β has been chosen as π/2 for convenience and standardization.

Given this normalization parameter α, an adjusted curvature fraction γ′, representing the fractional portion of the curvature held at the maximum radius within the remaining angular section β′, may be calculated as follows:

$${γ}^{′} = ( {πβ}^{′} {r}_{m i n}^{2} - {a}^{2} ) / ( {πβ}^{′} {r}_{m i n}^{2} ) ,$$

which may be bounded 0≤γ′≤1, ensuring a physically meaningful and practically achievable curvature profile. For a fixed α and a γ′ which tends to zero, an effective 1/rₘᵢₙ′≤1/rₘᵢₙ may be calculated from the same formula above as

$${r}_{m i n}^{′} = a √ ( π ( 1 - {γ}^{′} ) {β}^{′} ) .$$

Thus, by systematically adjusting parameters such as γ′, rₘᵢₙ′, and the normalization parameter α, designers can flexibly optimize the waveguide curvature profile to precisely complete the loop's desired angular extent β′. This analytical framework effectively provides greater control over critical curvature parameters, enhancing the accuracy and efficiency of iterative optimization methods used in the practical design and fabrication of adiabatic waveguide loops.

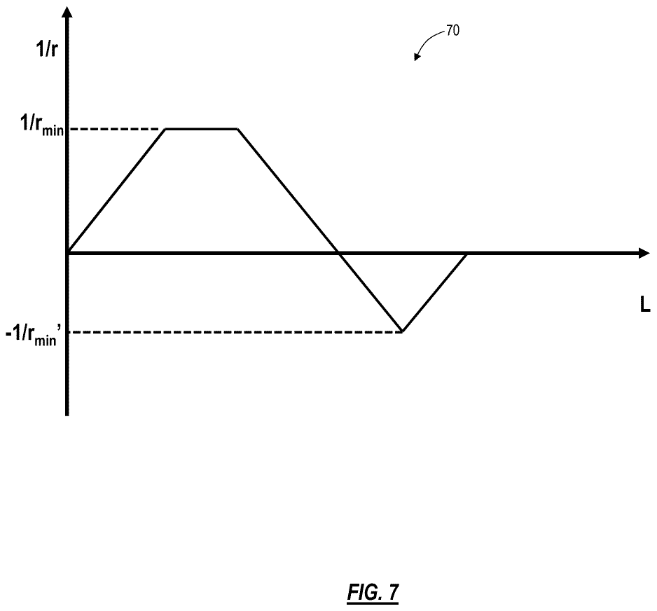

As illustrated in FIG. 7, the effective minimum radius of curvature rₘᵢₙ′, calculated according to the methods described above, may increase significantly as the adjusted curvature fraction γ′ approaches zero. To maintain practical device compactness and avoid excessively large waveguide loops, it is beneficial to limit rₘᵢₙ′ by imposing a predetermined upper bound—for instance, 2rₘᵢₙ.

In FIG. 7, an example is illustrated whereas, for γ≠0, and as γ′ tends to 0, rₘᵢₙ′ is capped, such that 1/rₘᵢₙ′<1/rₘᵢₙ. As with FIG. 1, the horizontal axis represents a propagation length along the loop and the vertical axis represents the local radius of curvature.

By applying such a capping criterion during the iterative optimization process, waveguide designers effectively balance the competing design considerations of compactness, minimal optical losses, and achievable offset Δy. Consequently, the capped approach represented in FIG. 7 enables realistic, high-performance adiabatic waveguide loop designs suitable for densely integrated photonic circuits.

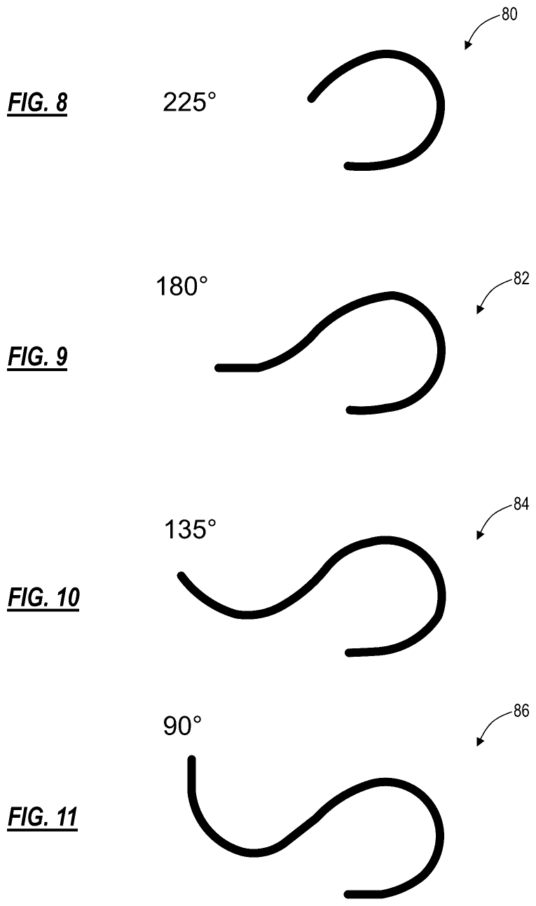

FIGS. 8, 9, 10, and 11 illustrate examples of optimized adiabatic waveguide loops 80, 82, 84, 86 designed according to the principles of the present disclosure, each configured to achieve a common vertical offset Δy but with distinct output angles. Each loop 80, 82, 84, 86 demonstrates a continuous, smoothly varying curvature profile, free of stationary points and unnecessary straight segments, resulting in highly compact, low-loss waveguide bends.

Specifically, FIG. 8 depicts an optimized loop 80 providing a vertical offset Δy with an output angle of 225°. This geometry demonstrates efficient routing for quarter-turn waveguide applications, such as connecting perpendicular waveguide channels in densely integrated photonic layouts.

FIG. 9 illustrates an optimized loop geometry achieving the same vertical offset Δy, but configured with an output angle of 180°. This design is particularly beneficial for tightly packed layouts requiring complete optical signal redirection, such as folded optical paths in interferometers, reflective configurations like Sagnac loops, or compact photonic delay lines.

FIG. 10 presents an optimized loop geometry with a vertical offset Δy and an output angle of 135°, demonstrating the flexibility of the disclosed method for more complex waveguide routing scenarios. This configuration is advantageous in multi-layer or highly integrated circuits where optical signals require significant directional rotation within constrained areas.

FIG. 11 illustrates yet another optimized waveguide loop design, achieving the predetermined vertical offset Δy, this time configured with a 90° angular turn. Such a geometry is especially useful in designs requiring optical feedback loops, tightly integrated resonators, or recirculation-type optical structures, where minimal footprint and extremely low propagation losses are critical.

Collectively, FIGS. 8-11 demonstrate the versatility and efficacy of the disclosed approach, highlighting that the systematic optimization method described herein is capable of providing tailored, compact waveguide loops with precise offsets, varied angular outputs, and minimal optical losses suitable for diverse photonic integration applications.

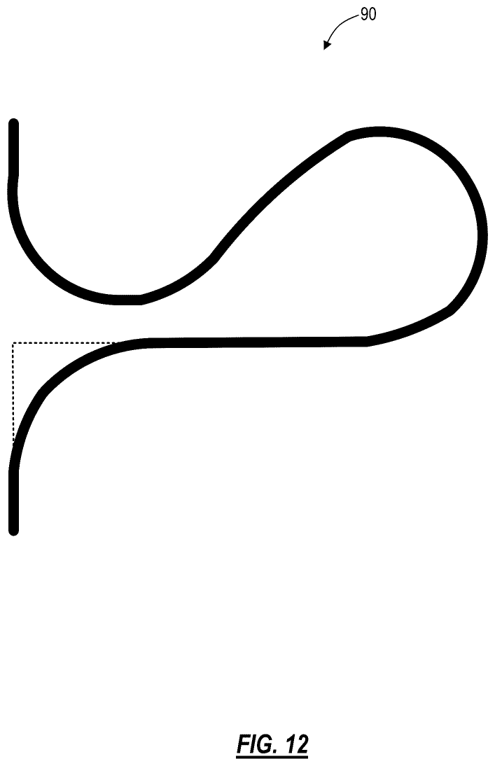

FIG. 12 illustrates a detailed example of a full optical routing path formed by combining multiple waveguide loops, specifically demonstrating the integration of the optimized compound adiabatic waveguide bends described herein into a more comprehensive photonic layout. In particular, FIG. 12 depicts how a compact optical delay line can be efficiently realized by sequentially joining two waveguide bends: a standard 90° adiabatic bend (without offset) and a 90° adiabatic bend explicitly configured with a predetermined lateral offset Δy. By arranging these two complementary bend structures in sequence, the layout provides a highly compact yet versatile optical routing path suitable for applications such as integrated delay lines, interferometers, or optical buffering components.

As depicted in FIG. 12, the first waveguide segment employs a conventional 90° adiabatic bend that smoothly transitions from zero curvature to maximum curvature (1/rₘᵢₙ) and back, without introducing any lateral offset. Subsequently, a second bend segment, carefully optimized according to the methods disclosed herein, smoothly transitions from zero curvature to maximum curvature, maintains a constant-curvature portion to achieve the desired lateral offset Δy, and then symmetrically returns to zero curvature. The seamless integration of these two bend geometries enables designers to precisely manage lateral offsets within densely integrated photonic circuits, thereby significantly reducing overall footprint, insertion losses, and propagation losses.

By combining multiple optimized bends in this manner, FIG. 12 exemplifies the practical utility of the disclosed adiabatic waveguide loop design principles, demonstrating how complex routing paths—such as compact delay lines, Sagnac loops, folded paths, or optical feedback configurations—can be efficiently implemented within stringent layout constraints.

Referring back to FIG. 4, in an embodiment, the improved waveguide bend geometry 24 provide an adiabatic waveguide loop 100 configured to achieve an arbitrary lateral offset. The adiabatic waveguide loop 100 includes a first adiabatic transition 102 configured to gradually ramp waveguide curvature from substantially zero (straight segment 104) to a predetermined maximum curvature (1/rₘᵢₙ) at a controlled curvature ramp rate λ; a circular segment 106 with a fixed radius of curvature rₘᵢₙ, wherein the length (L) of this circular segment 106 precisely determines a desired lateral offset Δy; a second adiabatic transition 108 configured to symmetrically ramp the waveguide curvature from the maximum curvature (1/rₘᵢₙ) back to substantially zero curvature; and at least one additional adiabatic transition 110 arranged to complete a total bend angle of at least 180°, or other predetermined angular values, while maintaining the same maximum curvature constraint (1/rₘᵢₙ). Advantageously, such an adiabatic waveguide loop 100 is specifically constructed without introducing unnecessary stationary points-positions along the waveguide path where curvature momentarily returns to zero-which effectively reduces the total optical path length and minimizes bend-induced scattering and radiation losses.

The circular segment 106 may be dimensioned to align the input and output waveguide axes precisely within space-constrained photonic layouts, thereby providing the targeted offset Δy. For instance, in an electro-optic (EO) modulator design, the offset Δy and total bend angle may be strategically selected to periodically realign an optical signal traveling in the waveguide with a co-propagating radio frequency (RF) signal on an adjacent electrode structure, thus minimizing velocity mismatch and substantially reducing EO degradation. Such EO modulators may be implemented using various material platforms known to require periodic optical-RF mode realignment, such as thin-film lithium niobate (TFLN), barium titanate (BaTiO₃ or BTO), silicon photonics platforms, or hybrid III-V semiconductor platforms.

The curvature ramp rate A and minimum radius rₘᵢₙ are typically empirically optimized by comparing measured optical propagation and insertion losses from standard or reference bend configurations across ranges of candidate A and rₘᵢₙ values. In practical implementations, the adiabatic waveguide loop may employ a precomputed dataset or a lookup table correlating circular segment length L directly to corresponding achievable offsets Δy, thereby significantly streamlining the waveguide design process across various photonic circuit footprints. Additionally, the parameter γ—which represents the fraction of total bend length spent at the maximum curvature (1/rₘᵢₙ)—is adjusted alongside λ and rₘᵢₙ to achieve an optimal balance among competing design factors, including minimal optical losses, compact device footprint, and practical fabrication constraints.

In another embodiment, a photonic device includes at least one adiabatic waveguide loop 100 as described herein and further includes one or more additional optical components, such as interferometers, Sagnac-based optical reflectors, multi-pass thermal phase shifters, 2×2 optical couplers, or combinations thereof. In such photonic devices, the disclosed adiabatic waveguide loop advantageously provides minimal insertion losses and maintains a precisely controlled lateral offset within an optimally compact physical layout. Moreover, this waveguide loop geometry is particularly beneficial for shortening delay lines within on-chip interferometers, effectively accommodating large-angle optical turns while minimally increasing the total waveguide path length and preserving optical signal integrity.

In a further embodiment, a method of forming an adiabatic waveguide loop configured for an arbitrary lateral offset includes selecting an appropriate curvature ramp rate A and a suitable minimum radius of curvature rₘᵢₙ; forming a first adiabatic transition that smoothly increases curvature from zero (1/r=0) to the predetermined maximum curvature (1/rₘᵢₙ); providing a circular segment at constant curvature (1/rₘᵢₙ) with a length (L) specifically chosen to achieve the targeted offset Δy; forming a second adiabatic transition that symmetrically ramps curvature back down to zero; and calculating additional adiabatic transition segments as necessary to complete a desired total bend angle exceeding, for example, 180°, while maintaining the maximum curvature constraint (1/rₘᵢₙ). The parameters λ, rₘᵢₙ, and L may be iteratively adjusted or selected from precomputed lookup tables to systematically minimize optical propagation losses and accurately achieve the desired offset Δy.

The method further includes precisely determining the required circular segment length L through iterative numerical algorithms such as the secant method, Newton-Raphson, or quasi-Newton techniques, which converge efficiently toward the exact L that yields the targeted offset Δy. Waveguide curvature profiles can be numerically integrated from Fresnel integrals or other clothoid-based functions, ensuring smooth and continuous curvature transitions throughout the waveguide path without introducing abrupt curvature discontinuities. The disclosed adiabatic waveguide loops can be fabricated using a variety of photonics-compatible material platforms, including silicon photonics, III-V semiconductor platforms, or hybrid material platforms such as thin-film BaTiO₃ integrated with silicon or lithium niobate substrates.

The method can also include integrating the optimized adiabatic waveguide loop within a radio-frequency (RF) traveling-wave electrode structure for an electro-optic modulator device, thus periodically realigning the RF and optical signals to effectively minimize velocity mismatch and enhance modulation performance. Testing and verifying the optical performance of the fabricated waveguide loop typically involves measuring optical propagation and insertion losses relative to a reference straight waveguide baseline. The measured results are used iteratively to refine curvature ramp rate λ, minimum radius rₘᵢₙ, and circular segment length L, ultimately achieving an optimal compromise between compact physical layout, precise offset alignment, and low optical loss characteristics suitable for high-performance integrated photonic circuits.

### CONCLUSION

As used herein, the terms “optimal,” “optimizing,” and “optimum” refer to achieving an improvement over conventional or prior art methods, rather than implying the attainment of absolute or theoretical perfection. Specifically, these terms encompass practical enhancements that meaningfully improve key performance attributes-such as reducing optical loss, decreasing device footprint, or improving fabrication tolerance-within realistic manufacturing and operational constraints. Thus, while an ideal or mathematically perfect solution is not necessarily implied, the disclosed techniques are directed toward elevating performance relative to existing or known methodologies.

Additionally, the term “substantially” and similar qualifiers are intended as broadening terms to reasonably include variations, deviations, or tolerances that do not materially alter the essential characteristics or intended function described. For example, “substantially zero curvature” refers to curvature sufficiently close to zero such that the optical waveguide behaves effectively as a straight segment with negligible curvature-induced loss. Similarly, stating that an adiabatic bend “substantially eliminates sharp transitions” indicates that the bend is designed to smoothly vary curvature to the extent that abrupt changes are minimized to the point of having negligible optical impact. Further, “substantially reducing electro-optic (EO) degradation” means that EO degradation is lowered to a level where performance improvements in velocity matching yield meaningful and beneficial enhancements to modulator efficiency, even though such degradation may not be entirely eliminated.

Further, the terms “loop,” “bend,” and “curve” as used herein are interchangeable and do not require or imply a closed path that returns or “loops” onto itself. Instead, these terms broadly describe any continuous, smoothly varying curvature profile in a waveguide geometry, specifically including configurations where the waveguide begins and ends at distinct points without forming a closed loop. Thus, “loop,” “bend,” and “curve” encompass waveguide paths that redirect optical signals through arbitrary angular changes or lateral offsets, characterized by smoothly transitioning curvature profiles that avoid abrupt discontinuities, stationary points, or redundant straight segments.

In this disclosure, including the claims, the phrases “at least one of” or “one or more of” when referring to a list of items mean any combination of those items, including any single item. For example, the expressions “at least one of A, B, or C,” “at least one of A, B, and C,” “one or more of A, B, or C,” and “one or more of A, B, and C” cover the possibilities of: only A, only B, only C, a combination of A and B, A and C, B and C, and the combination of A, B, and C. This can include more or fewer elements than just A, B, and C. Additionally, the terms “comprise,” “comprises,” “comprising,” “include,” “includes,” and “including” are intended to be open-ended and non-limiting. These terms specify essential elements or steps but do not exclude additional elements or steps, even when a claim or series of claims includes more than one of these terms.

Although operations, steps, instructions, blocks, and similar elements (collectively referred to as “steps”) are shown or described in the drawings, descriptions, and claims in a specific order, this does not imply they must be performed in that sequence unless explicitly stated. It also does not imply that all depicted operations are necessary to achieve desirable results. In the drawings, descriptions, and claims, extra steps can occur before, after, simultaneously with, or between any of the illustrated, described, or claimed steps. Multitasking, parallel processing, and other types of concurrent processing are also contemplated. Furthermore, the separation of system components or steps described should not be interpreted as mandatory for all implementations; also, components, steps, elements, etc. can be integrated into a single implementation or distributed across multiple implementations.

While this disclosure has been detailed and illustrated through specific embodiments and examples, it should be understood by those skilled in the art that numerous variations and modifications can perform equivalent functions or achieve comparable results. Such alternative embodiments and variations, even if not explicitly mentioned but that achieve the objectives and adhere to the principles disclosed herein, fall within the spirit and scope of this disclosure. Accordingly, they are envisioned and encompassed by this disclosure and are intended to be protected under the associated claims. In other words, the present disclosure anticipates combinations and permutations of the described elements, operations, steps, methods, processes, algorithms, functions, techniques, modules, circuits, and so on, in any conceivable order or manner—whether collectively, in subsets, or individually—thereby broadening the range of potential embodiments.

What is claimed is:

1. An adiabatic waveguide loop comprising:
a first adiabatic transition configured to gradually ramp waveguide curvature from substantially zero to a predetermined maximum curvature (1/rₘᵢₙ) at a curvature ramp rate λ;
a circular segment with a radius of curvature rₘᵢₙ, having a length (L) configured to achieve a predetermined lateral offset Δy;
a second adiabatic transition configured to symmetrically ramp the waveguide curvature from the maximum curvature (1/rₘᵢₙ) back to substantially zero curvature; and
at least one additional adiabatic transition configured to complete a desired loop angle.

2. The adiabatic waveguide loop of claim 1, wherein curvature transitions in the waveguide curvature vary continuously and smoothly along an entire propagation path without abrupt changes in curvature.

3. The adiabatic waveguide loop of claim 1, wherein the curvature ramp rate A and minimum radius of curvature rₘᵢₙ are empirically optimized to minimize propagation losses.

4. The adiabatic waveguide loop of claim 1, wherein the circular segment length (L) is determined using a numerical optimization technique including at least one of a secant method, Newton-Raphson method, or a lookup table of precomputed L−Δy values.

5. The adiabatic waveguide loop of claim 1, wherein the adiabatic waveguide loop is integrated into an electro-optic (EO) modulator configured for periodic velocity matching between optical and radio frequency (RF) signals.

6. The adiabatic waveguide loop of claim 5, wherein the EO modulator comprises at least one material selected from thin-film lithium niobate (TFLN), barium titanate (BaTiO₃), silicon photonics, III-V semiconductors, or hybrid combinations thereof.

7. The adiabatic waveguide loop of claim 1, further comprising
an adjusted curvature fraction γ representing a portion of the total bend length at maximum curvature (1/rₘᵢₙ).

8. The adiabatic waveguide loop of claim 7, wherein γ is adjusted in combination with curvature ramp rate λ and radius rₘᵢₙ to balance device footprint, optical losses, and fabrication constraints.

9. The adiabatic waveguide loop of claim 1, wherein the waveguide loop is fabricated on a silicon photonics platform.

10. The adiabatic waveguide loop of claim 1, integrated into a photonic device comprising at least one of interferometers, Sagnac reflectors, multi-pass thermal phase shifters, and 2×2 optical couplers.

11. The adiabatic waveguide loop of claim 1, wherein the curvature ramp rate λ, radius rₘᵢₙ, and circular segment length L are chosen to minimize overall optical losses and device footprint.

12. The adiabatic waveguide loop of claim 1, further comprising
a capping limit imposed on an effective minimum radius of curvature (rₘᵢₙ′) to maintain compactness.

13. A method of forming an adiabatic waveguide loop with an arbitrary lateral offset (Δy), comprising:
selecting a curvature ramp rate λ and a minimum radius of curvature rₘᵢₙ;
forming a first adiabatic curvature transition from substantially zero curvature to a predetermined maximum curvature (1/rₘᵢₙ);
providing a circular segment at constant curvature (1/rₘᵢₙ) having a length L selected to achieve a targeted offset Δy;
forming a second adiabatic curvature transition from the maximum curvature (1/rₘᵢₙ) back to substantially zero curvature; and
forming additional adiabatic segments configured to complete a desired total bend angle while maintaining curvature continuously varying.

14. The method of claim 13, further comprising
iteratively adjusting at least one of the curvature ramp rate λ, radius rₘᵢₙ, or circular segment length L to minimize optical propagation losses.

15. The method of claim 13, wherein the length L is determined through numerical iterative methods including at least one of a secant method, Newton-Raphson method, or quasi-Newton optimization techniques.

16. The method of claim 13, wherein curvature profiles are numerically integrated from Fresnel integrals to ensure smooth curvature transitions throughout a waveguide path.

17. The method of claim 13, further comprising
precomputing a lookup table correlating circular segment lengths L with lateral offsets Δy to streamline waveguide loop design.

18. The method of claim 13, further comprising
integrating the waveguide loop into an electro-optic modulator configured to periodically realign optical and radio frequency signals, reducing velocity mismatch.

19. The method of claim 18, further comprising
empirically optimizing curvature parameters A and rₘᵢₙ by measuring optical losses relative to reference waveguide bends.

20. The method of claim 13, further comprising
imposing a practical upper limit on an effective minimum radius of curvature (rₘᵢₙ′) to ensure device compactness and fabrication feasibility.
